(19) United States
(12) Patent Application Publication
(10) Pub. No.: US 2004/0001475 A1
(43) Pub. Date: Jan. 1, 2004

(54) Routing for virtual private networks

(76) Inventor: Olli Mikkonen, Kirkkonummi (FI)

Correspondence Address: PILLSBURY WINTHROP, LLP, P.O. BOX 10500, MCLEAN, VA, 22102, US

(21) Appl. No.: 10/185,714

(22) Filed: Jul. 1, 2002

(51) Int. Cl. H04L 12/28

(52) U.S. Cl. 370/351

(57) ABSTRACT

A method of routing a data packet, whereby a piece of information, which is indirectly associated with with the data packet, such as user identity, is first determined and then the data packet is routed at least partially on the basis of said piece of information.

### FIELD OF THE INVENTION

The present invention relates to routing data packets in data networks and especially to routing data packets with regard to virtual private networks (VPN).

### BACKGROUND OF THE INVENTION

In data networks such as Internet, information is transferred in data packets, which are routed to their destination on the basis of a destination address, such as Internet Protocol (IP) address, included in the data packet. Originally, one IP address was associated with one physical machine and data packets could be routed to the correct destination simply on the basis of the destination address. But nowadays, sole destination address does not always identify the destination device unambiguously.

For example, due to limited amount of IP addresses and lack of inherent security in the Internet, organizations often use only a limited number of public IP addresses and hide IP addresses of their internal networks behind these public addresses by means of Network Address Translation (NAT). In this kind of arrangement the IP addresses used in various different internal networks (internal addresses) can be the same. Usually, this does not cause any problems, since often there is a device sitting in the border of the internal network taking care of translating internal addresses to public addresses and vice versa, and forwarding the data packets to correct destinations.

However, there are several situations, where routing data packets solely on the basis of the destination address does not work. One solution for finding correct destination is to use source IP address and/or source/destination ports, which can also be found in a data packet, as a basis of the routing decision. However, even this is does not help in all cases and there is a need for a new routing solution.

### SUMMARY OF THE INVENTION

An object of the invention is to provide a new method, computer program product and network element for routing data packets.

This object of the invention is achieved according to the invention as disclosed in the attached independent claims. Preferred embodiments of the invention are disclosed in the dependent claims. The features described in one dependent claim may be further combined with features described in another dependent claim to produce further embodiments of the invention.

The idea of the invention is to route data packets on the basis of information, which is not inherently available in the data packet to be routed. That is, according to the invention a piece of information, which is indirectly associated with the data packet, is first determined, and the data packet is routed at least partially on the basis of said piece of information. Said information may be for example a user identity associated with the data packets or time of the day or date. Being indirectly associated with the data packet herein means that the information that is used for making routing decision cannot be obtained directly from the data packet, but an additional action is needed: e.g. for obtaining user identity authentication service is needed and time of the day or date are obtained for example from the system, which is implementing the invention.

According to one aspect of the invention a user identity associated with a data packet is first determined, and the data packet is routed at least partially on the basis of said user identity.

According to another aspect of the invention, routing information is included in a firewall or VPN rule, and routing the data packet comprises finding a filtering rule matching at least with said user identity, obtaining routing information from said filtering rule, and routing the data packet on the basis of the routing information.

In addition to the user identity for example time of day and/or date can be used for finding matching rule and consequently routing information for the data packet.

The invention is especially suitable for virtual private networks. Virtual private networks are means for communicating privately over public networks. For example a laptop connected to the Internet can communicate securely with a server sitting in the internal network of an organization. Internal addressing of the server is used in the actual data packets, but for delivery over the Internet the actual data packets from the laptop are encrypted and encapsulated into an outer data packet addressed to a VPN gateway sitting in the border of the internal network. The VPN gateway then decapsulates the data packet and forwards it to the original destination on the basis of the address found in the internal data packet. VPNs are commonly set up between two VPN gateways as well. However, specific details of a VPN implementation are not relevant considering the invention, and are thus not discussed herein any further.

A potential problem in routing data packets in connection with VPNs is caused for example when a Managed Service Provider (MSP) offers VPN gateway service to multiple customers. Let's consider for example that an MSP uses one VPN gateway for handling VPN connections of multiple customers, each customer having own interface to the VPN gateway, and in the same time allows the customers to choose overlapping internal addresses for use. Now, if a data packet of a VPN connection from a given external source to an internal address X arrives at the VPN gateway and the internal address X is in use in more than one internal network connected to the VPN gateway, it is impossible to find out on the basis of the destination address, which X is the correct destination. Even the use of source address does not help, since mobile terminals typically use dynamic IP addresses and thus the source address does not offer any additional information. But the method of the invention solves this problem as user identity is used for routing. According to the invention different customers register with the MSP the user identities, which are allowed to use their VPN. VPN gateway of the MSP can then easily find the correct internal network for a given data packet by finding the internal network related to the user identity associated with the data packet.

Another problem that can be solved with the invention is that even though all customer networks connected to MSP's VPN gateway employed different internal address spaces, a customer may want that all traffic originating from laptops of the customer need to be routed through it's internal network. That is, even traffic whose destination is in the Internet should be directed to the internal network of the customer and to the Internet only from thereon. This way the customer can enforce it's own security policy for the traffic before allowing it to proceed. In this case prior art solutions do not offer any way for the VPN gateway to know, which internal network is the correct destination for a decrypted data packet wherein the destination address points towards the Internet. But by basing the routing decision on the user identity according to the invention, the correct destination can be found.

### BRIEF DESCRIPTION OF THE DRAWINGS

Various features of the invention, as well as the advantages offered thereby, are described hereinafter in more detail with reference to embodiments illustrated in the accompanying drawings, in which

FIG. 1 illustrates an example network configuration,

FIG. 2A is a flow chart illustrating an aspect of the method of the invention, and

FIG. 2B is a flow chart illustrating another aspect of the method of the invention.

### PREFERRED EMBODIMENTS OF THE INVENTION

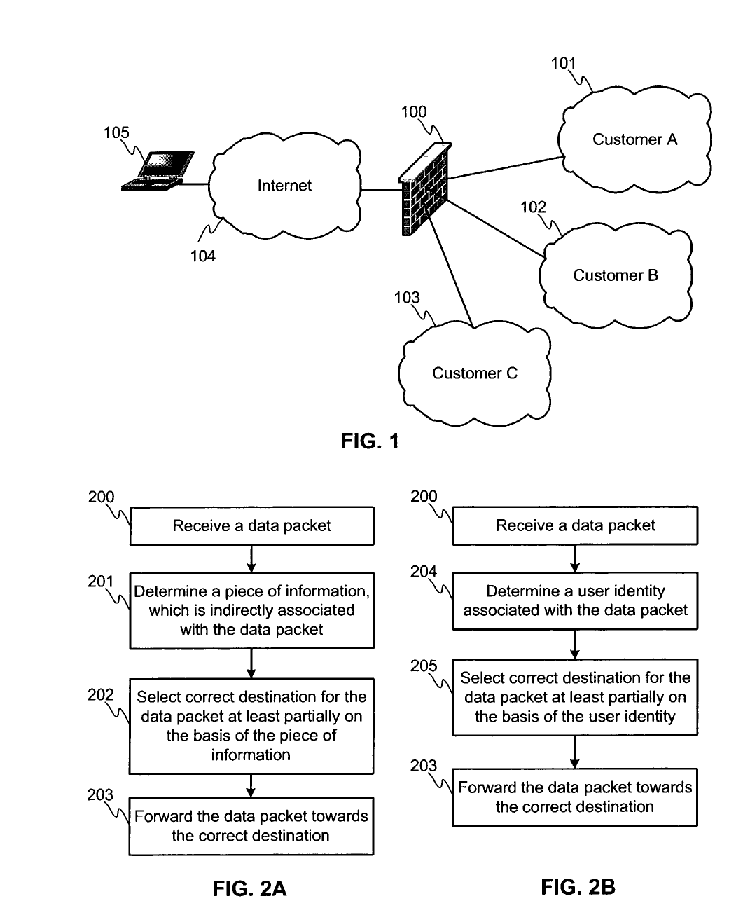

FIG. 1 illustrates an example network configuration, wherein the invention may be used. Internal networks of customers A, B and C 101-103 are connected to the Internet 104 via a firewall 100, which is administered by an MSP (not shown in Figure). The firewall operates also as a VPN gateway for the internal networks and enables secure remote connections from devices connected to the Internet, such as laptop 105, to the internal networks. When a data packet from the laptop 105 arrives at the firewall 100, the next hop from the firewall onwards for the data packet is decided according to the invention at least partly on the basis of the user identity associated with the data packet or laptop.

The invention can be employed in any network element, which is routing data packets in communication networks. The network element can be a firewall, such as firewall 100 in FIG. 1, a VPN gateway, a router, a personal computer (PC), or whatever that can be used for such purposes. Physically the network element is a computer hardware device combined with appropriate software to do the tasks assigned to it.

The invention can be implemented for example in firewall rules. Firewall rules are used for configuring the firewall. Rules (forming a rule base) define which data packets are allowed to traverse the firewall and which are not. A rule comprises information for identifying a data packet (e.g. source and destination addresses and ports, user identity) and an associated action, which may be for example to allow or deny the packet. Usually everything that is not explicitly allowed in the rules is denied. The action may be also something else than simply allow or deny. For example, the action defined in the rule may indicate that some further action needs to be taken before releasing a data packet, which is in principle allowed. Such further processing may be for example network address translation (NAT), encryption, decryption or virus checking. Also deny action may include further processing. According to one aspect of the invention routing information is included in the rule, and all other routing rules are overridden for data packets, which match to a rule containing routing information. By making the routing decision dependent on firewall rules, all information that is used for filtering data packets in the firewall can be used for making routing decisions. Thus a routing decision can be based on destination address, as well as source address or port or destination port but also on any other information in rules, such as user identity obtained from authentication process or time of the day or date.

Routing information included in a rule can be for example a gateway, to which the data packet is directed, or a network interface card (NIC) or a network link, which is used for forwarding the data packet.

FIG. 2A is a flow diagram illustrating an aspect of the method of the invention. In step 200 a data packet is first received at the device implementing the invention. Then a piece of information, which is indirectly associated with the data packet, that is information which is not inherently available in the data packet, is determined in step 201. Correct destination is selected for the data packet at least partially on the basis of the piece of information in step 202. Selecting the destination does not necessarily mean selecting final destination for the data packet, but the next hop for the data packet. For example, a gateway associated with the user identity is selected from a list. Clearly selection of the destination does not need to be purely on the basis of the piece of information, which is indirectly associated with the data packet, but also information, which is readily available in the data packet, can be used. For example source and destination addresses can be taken into account where suitable. Then in step 203, the data packet is forwarded towards the destination (e.g. to the correct NIC or to the next gateway). Routing information (information about the next hop) is advantageously included in a firewall or VPN rule and data packet is automatically routed on the basis of the routing information included in a rule, to which the data packet matches.

FIG. 2B is a flow diagram illustrating another aspect of the method of the invention. In step 200 a data packet is first received at the device implementing the invention. Then a user identity associated with the data packet is determined in step 204 for example by means of an authentication

1. A method of routing a data packet comprising
determining a piece of information, which is indirectly associated with the data packet, and
routing the data packet at least partially on the basis of said piece of information.

2. A method as claimed in claim 1, wherein said piece of information is user identity associated with the data packet.

3. A method as claimed in claim 1, wherein said piece of information is time of day and/or date.

4. A method of routing a data packet comprising
determining a user identity associated with the data packet, and
routing the data packet at least partially on the basis of said user identity.

5. A method as claimed in claim 4, wherein the step of routing comprises
finding a filtering rule matching at least with said user identity,
obtaining routing information from said filtering rule, and
routing the data packet on the basis of the routing information.

6. A method as claimed in claim 5, wherein the filtering rule is a firewall rule or a virtual private network rule.

7. A method as claimed in claim 5, further comprising
determining time of day and/or date, and wherein the step of finding a filtering rule comprises
finding a filtering rule matching with the time of day and/or date in addition to said user identity.

8. A computer program product comprising computer program code which, when executed in a computer device, provides a routine of routing a data packet, the routine comprising

1. A method of routing a data packet comprising
determining a piece of information, which is indirectly associated with the data packet, and
routing the data packet at least partially on the basis of said piece of information.

2. A method as claimed in claim 1, wherein said piece of information is user identity associated with the data packet.

3. A method as claimed in claim 1, wherein said piece of information is time of day and/or date.

4. A method of routing a data packet comprising
determining a user identity associated with the data packet, and
routing the data packet at least partially on the basis of said user identity.

5. A method as claimed in claim 4, wherein the step of routing comprises
finding a filtering rule matching at least with said user identity,
obtaining routing information from said filtering rule, and
routing the data packet on the basis of the routing information.

6. A method as claimed in claim 5, wherein the filtering rule is a firewall rule or a virtual private network rule.

7. A method as claimed in claim 5, further comprising
determining time of day and/or date, and wherein the step of finding a filtering rule comprises
finding a filtering rule matching with the time of day and/or date in addition to said user identity.

8. A computer program product comprising computer program code which, when executed in a computer device, provides a routine of routing a data packet, the routine comprising
determining a piece of information, which is indirectly associated with the data packet, and
routing the data packet at least partially on the basis of said piece of information.

9. A computer program product as claimed in claim 8, wherein said piece of information is user identity associated with the data packet.

10. A computer program product as claimed in claim 8, wherein said piece of information is time of day and/or date.

11. A computer program product comprising computer program code which, when executed in a computer device, provides a routine of routing a data packet, the routine comprising
determining a user identity associated with the data packet, and
routing the data packet at least partially on the basis of said user identity.

12. A computer program product as claimed in claim 11, wherein the step of routing comprises
finding a filtering rule matching at least with said user identity,
obtaining routing information from said filtering rule, and
routing the data packet on the basis of the routing information.

13. A computer program product as claimed in claim 12, wherein the filtering rule is a firewall rule or a virtual private network rule.

14. A computer program product as claimed in claim 12, further comprising
determining time of day and/or date, and wherein the step of finding a filtering rule comprises
finding a filtering rule matching with the time of day and/or date in addition to said user identity.

15. A network element for routing data packets, comprising
a programmed computer, further comprising
a memory having at least one region for storing executable program code, and
a processor for executing the program code stored in the memory, wherein the program code further comprises
program code for determining a piece of information, which is indirectly associated with the data packet, and
program code for routing the data packet at least partially on the basis of said piece of information.

16. A network element as claimed in claim 16, wherein said piece of information is user identity associated with the data packet.

17. A network element as claimed in claim 16, wherein said piece of information is time of day and/or date.

18. A network element for routing data packets, comprising
a programmed computer, further comprising
a memory having at least one region for storing executable program code, and
a processor for executing the program code stored in the memory, wherein the program code further comprises
program code for determining a user identity associated with the data packet, and
program code for routing the data packet at least partially on the basis of said user identity.

19. A network element as claimed in claim 18, wherein the program code for routing further comprises
program code for finding a filtering rule matching at least with said user identity,
program code for obtaining routing information from said filtering rule, and
program code for routing the data packet on the basis of the routing information.

20. A network element as claimed in claim 19, wherein the filtering rule is a firewall rule or a virtual private network rule.

21. A network element as claimed in claim 19, the program code further comprising
program code for determining time of day and/or date, and wherein the program code for finding a filtering rule is adapted to
find a filtering rule matching with the time of day and/or date in addition to said user identity.
